(19) United States
(12) Patent Application Publication
(10) Pub. No.: US 2011/0074742 A1
(43) Pub. Date: Mar. 31, 2011

(54) PLASMA DISPLAY DEVICE

(75) Inventor: Seung-Hun Chae, Yongin-si (KR)

(73) Assignee: Samsung SDI Co., Ltd., Yongin-si (KR)

(21) Appl. No.: 12/877,870

(22) Filed: Sep. 8, 2010

(30) Foreign Application Priority Data
Sep. 30, 2009 (KR) 10-2009-0093495

(51) Int. Cl. G09G 3/28; G09G 5/00

(52) U.S. Cl. 345/204; 345/60

(57) ABSTRACT

Disclosed is a plasma display device including a plasma display panel (PDP) including: a plurality of electrodes; a printed circuit board assembly (PBA) to drive the plasma display panel (PDP); and a chassis base including a first surface supporting the plasma display panel (PDP) and a second surface mounted with the printed circuit board assembly (PBA), wherein the edge of the plasma display panel (PDP) includes power signal lines to supply power to electrodes, the power signal lines are separated from the electrodes on the edge of the plasma display panel (PDP), the power signal lines are connected to the electrodes through the interface flexible printed circuit (FPC), and the resistivity of the power signal lines is lower than that of the electrodes.

### CROSS-REFERENCE TO RELATED APPLICATION

This application claims the benefit of Korean Patent Application No. 10-2009-0093495, filed Sep. 30, 2009 in the Korean Intellectual Property Office, the disclosure of which is incorporated herein by reference.

### BACKGROUND

1. Field

The described technology relates generally to a plasma display device removing/reducing an address buffer board assembly and forming a part of constituents generated due to the removing/reducing to a plasma display panel (PDP).

2. Description of the Related Technology

Generally, a plasma display device includes a plasma display panel (PDP) displaying images, a chassis base supporting the PDPs, and a plurality of printed circuit board assemblies (PBAs) installed in the chassis base. The PBAs include an address board assembly, a logic board assembly, and a power supply board assembly. The address buffer board assembly is connected to an address electrode through a flexible printed circuit (FPC) (such as a tape carrier package (TCP)) to receive a voltage and a control signal from the power supply board assembly and the logic board assembly, and to apply the signals to the address electrodes provided in the PDP.

The power supply board assembly applies an address voltage Va to the address buffer board assembly. The logic board assembly applies a driver IC operation voltage Vcc, a driver IC control signal, a clock signal, and an address data signal to the address buffer board assembly. The address buffer board assembly controls selected address electrodes according to the signals.

The above information disclosed in this Background section is only for enhancement of understanding of the background of the described technology and therefore it may contain information that does not form the prior art that is already known in this country to a person of ordinary skill in the art.

### SUMMARY

An exemplary embodiment of the present invention relates to a plasma display device removing/reducing an address buffer board assembly and forming a part of constituents generated due to the removing/reducing to a plasma display panel (PDP).

In a plasma display device according to an exemplary embodiment of the present invention, the portion of the constituents of the function related to the removing/reducing is included in the logic board assembly such that the power signal lines connecting the integrated board assembly and the address electrodes instead of the address buffer board assembly are formed on the edge of the PDP.

In a plasma display device according to an exemplary embodiment of the present invention, the power signal lines formed on the edge of the PDP are made of a material having lower resistivity than that of the electrodes or the address electrodes of the PDP.

A plasma display device according to an exemplary embodiment of the present invention includes: a plasma display panel (PDP) including a plurality of electrodes; a printed circuit board assembly (PBA) to drive the plasma display panel (PDP); and a chassis base including a first surface supporting the plasma display panel (PDP) and a second surface mounted with the printed circuit board assembly (PBA), wherein the edge of the plasma display panel (PDP) includes power signal lines to supply power to electrodes, the power signal lines are separated from the electrodes on the edge of the plasma display panel (PDP), the power signal lines are connected to the electrodes through an interface flexible printed circuit (FPC), and the resistivity of the power signal lines is lower than that of the electrodes.

According to an aspect of the invention, the power signal lines may include one of Au and Mo.

According to an aspect of the invention, the power signal lines may have a higher content of Ag than the electrodes.

According to an aspect of the invention, the electrodes and the power signal lines may be made of different materials.

According to an aspect of the invention, the electrodes may include an address electrode, and the flexible printed circuit (FPC) may mount a driver IC generating a control signal to be applied to the address electrode.

A plasma display device according to an exemplary embodiment of the present invention includes: a plasma display panel (PDP) including a front substrate, a rear substrate, a plurality of electrodes between the front substrate and the rear substrate, and power signal lines separated from the plurality of electrodes and formed at the rear substrate; a chassis base close to the rear substrate; and a plurality of printed circuit board assemblies (PBAs) mounted to the chassis base, wherein the power signal lines transmit power and a signal used to drive the plurality of electrodes from at least one among the plurality of printed circuit board assemblies (PBAs), and the resistivity of the power signal lines is lower than that of the electrodes.

A plasma display device according to an exemplary embodiment of the present invention includes a plasma display panel (PDP) including a plurality of electrodes, a printed circuit board assembly (PBA) to drive the PDP, and a chassis base including a first surface supporting the PDP and a second surface mounted with the PBA. The PBA includes a sustain board assembly, a scan board assembly, a logic board assembly, a mini-board assembly and a power supply board assembly. The mini-board assembly is provided between the logic board assembly and the interface flexible printed circuit (FPC) thereby controlling the address electrodes among the electrodes. The PDP includes power signal lines formed on the edge and connected to the mini-board assembly by the interface flexible printed circuit (FPC). The power signal lines are connected to the address electrodes by the flexible printed circuit (FPC) mounted with the driver IC, and are made of a material having lower resistivity than that of the address electrodes.

According to an aspect of the invention, the mini-board assembly may apply a voltage applied from the power supply board assembly to the address electrodes as an address voltage by passing through the interface flexible printed circuit (FPC), the power signal lines, and the flexible printed circuit (FPC).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display device according to an exemplary embodiment of the present invention.

FIG. 2 is a cross-sectional view taken along the line II-II of FIG. 1.

FIG. 3 is a perspective view of the PDP shown in FIG. 1 from the front upper side.

FIG. 4 is a view showing a connection state of power signal lines, and a flexible printed circuit (FPC) and an interface flexible printed circuit (FPC) formed on the edge of the PDP of FIG. 3.

FIG. 5 is a rear view of a chassis base of a plasma display device according to an exemplary embodiment of the present invention.

### DETAILED DESCRIPTION OF CERTAIN INVENTIVE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

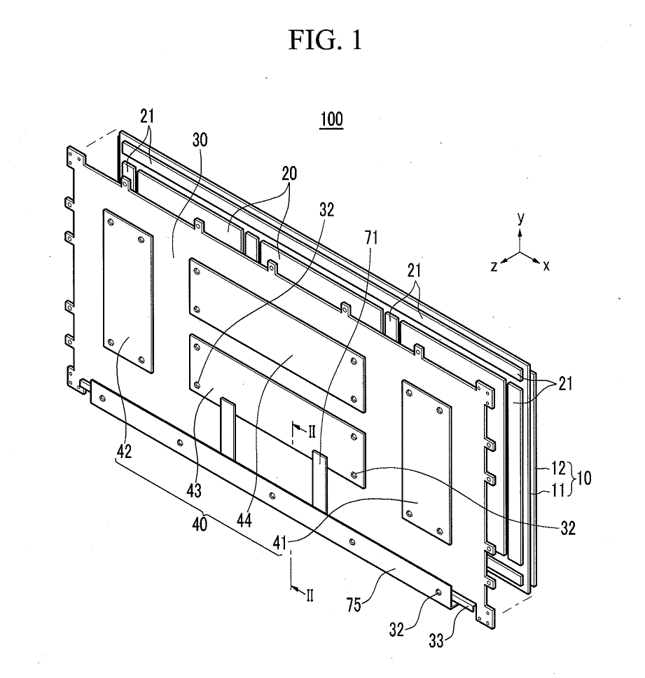

FIG. 1 is an exploded perspective view of a plasma display device 100 according to an exemplary embodiment of the present invention. As shown in FIG. 1, the plasma display device 100 includes a plasma display panel (PDP) 10 displaying images by using gas discharge, a heat dissipation sheet 20, a chassis base 30, and printed circuit board assemblies (PBAs) 40.

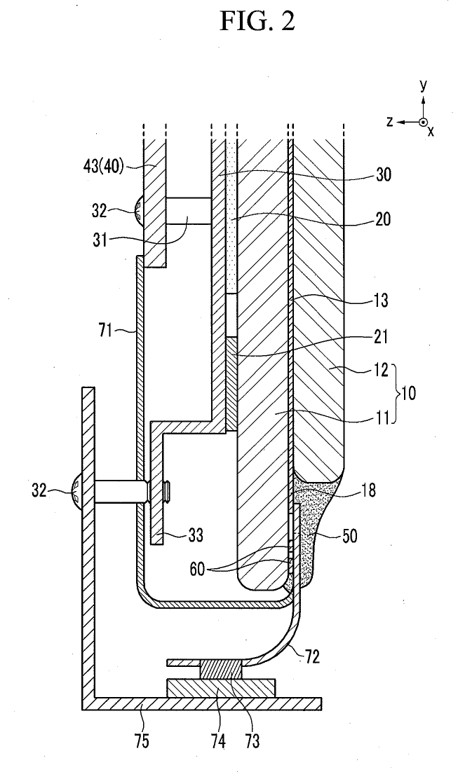

FIG. 2 is a cross-sectional view taken along the line II-II of FIG. 1. As shown in FIG. 2, the PDP 10 includes a rear substrate 11 and a front substrate 12 made of glass. Electrodes generate the gas discharge between the rear substrate 11 and the front substrate 12. The electrodes include sustain electrodes, scan electrodes (not shown), and address electrodes 13.

The heat dissipation sheet 20 is provided between the PDP 10 and the chassis base 30. As such, the heat generated in the PDP 10 by the gas discharge may be continuously diffused. The chassis base 30 is attached to the rear substrate 11 of the PDP 10 by double-sided adhesive tape 21 via the heat dissipation sheet 20, thereby supporting the PDP 10.

PBAs 40 are constituted to drive the PDP 10, and are electrically connected (not shown) to the PDP 10. The PBAs 40 perform their respective functions for driving the PDP 10, and for this purpose, are formed separately. For example, the PBAs 40 includes a sustain board assembly 41, a scanning board assembly 42, an integrated board assembly 43, and a power supply board assembly 44.

The sustain board assembly 41 is connected to the sustain electrodes (not shown) by a flexible printed circuit (FPC) (not shown) thereby controlling the sustain electrodes. The scanning board assembly 42 is connected to the scan electrodes (not shown) by the FPC, thereby controlling the scan electrodes. The integrated board assembly 43 receives video signals from an external source to generate each of the control signals to drive the address electrodes 13, the sustain electrodes, and the scan electrodes, and selectively applies the signals to the corresponding board assemblies 41, 42. The power supply board assembly 44 supplies power for the driving the board assemblies 41, 42, 43.

As compared to the conventional art, in the shown exemplary embodiment of the present invention, an address buffer board assembly for driving the address electrodes 13 is not separately provided. That is, the PBAs 40 do not additionally include the address buffer board assembly.

The PDP 10 is attached to a first surface (that is, the front surface of the chassis base 30) so as to be supported. The PBAs 40 are mounted at a second surface (that is, the rear surface of the chassis base 30). The plurality of PBAs 40 (in FIG. 2, an integrated board assembly 43 is exemplarily shown) are respectively disposed at a plurality of bosses 31 provided at the chassis base 30. The PBAs 40 are coupled with setscrews 32 such that the PBAs 40 are mounted to the chassis base 30.

As described above, the address buffer board assembly is eliminated such that the constituents related to the functions that are generally executed in the address buffer board assembly are reconstituted in the conventional logic board assembly. As a result, the integrated board assembly 43 is completed.

Compared with the conventional art which also includes the address buffer board assembly, the address electrodes 13 should be smoothly controlled. For this purpose, the PDP 10 includes power signal lines 60 formed on the edge thereof, and an interface flexible printed circuit (FPC) 71. The FPC 71 connects the integrated board assembly 43 and the power signal lines 60. The interface FPC 71 may be connected to the integrated board assembly 43 by a connector (not shown), or may be connected directly by heat compression.

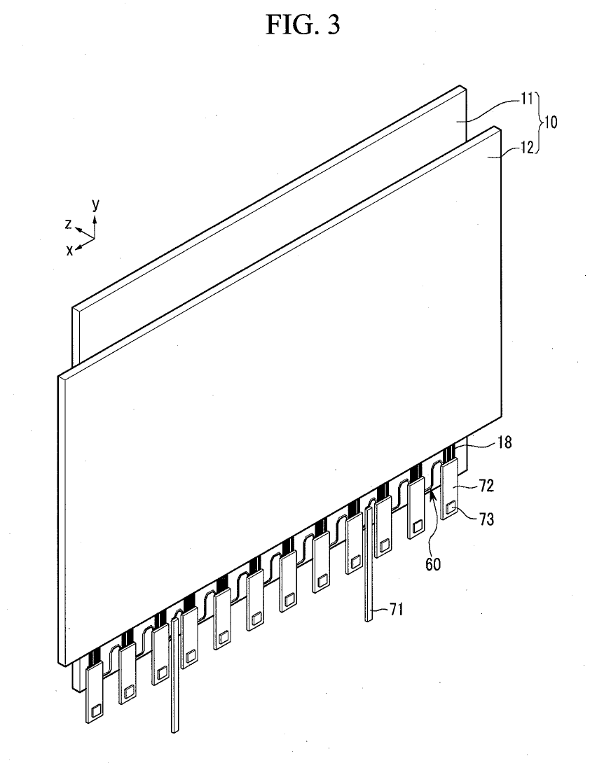

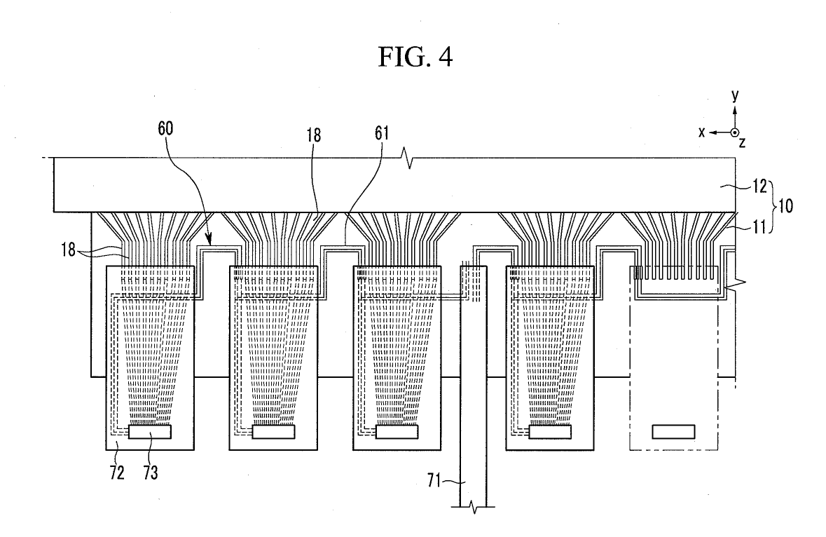

FIG. 3 is a perspective view of the PDP 10 shown in FIG. 1 from a front upper side, and FIG. 4 is a view showing a connection state of power signal lines 60, and a flexible printed circuit (FPC) and an interface flexible printed circuit (FPC) 71, formed on the edge of the PDP 10 of FIG. 3. Referring to FIGS. 1 through 4, the power signal lines 60 are formed in a non-display region of the PDP 10 (that is, the edge of the rear substrate 11). The power signal lines 60 and interface FPC 71 are capable of electrically connecting the integrated board assembly 43 to the address electrodes 13. The integrated board assembly 43 has a function of controlling the address electrodes 13.

Also, a driver integrated circuit (IC) 73 is mounted to a tape carrier package (TCP) 72. One side of the TCP 72 is connected to the power signal lines 60, and the other side of the TCP 72 is connected to the address electrodes 13. Accordingly, the interface FPC 71 applies the voltage and the control signal of the integrated board assembly 43 to the power signal lines 60. The TCP 72 selectively applies the address voltage and control signals generated in the driver IC 73 driven by the voltage and the control signal applied from the power signal lines 60 to the address electrodes 13. In this way, the address electrodes 13 may be controlled by the integrated board assembly 43 and the driver IC 73.

In the plasma display device 100, the address buffer board assembly is removed, the constituents of the functions related thereto are formed on the edge of the PDP 10 and the integrated board assembly 43, such that the constituents may be simplified and the manufacturing cost may be reduced.

The power signal lines 60 connected to the interface FPC 71 are electrically connected to the address electrodes 13 through the TCP 72 connected thereto. As shown, the power signal lines 60 are made of a material having less resistivity than that of the address electrodes 13. Accordingly, a drop of the address voltage applied to the address electrodes 13 in the power signal lines 60 and a delay of the control signals is decreased.

That is, the address electrodes 13 and the power signal lines 60 are made of different materials. For example, the address electrodes 13 include Ag, and the power signal lines 60 include one of Au and Mo. Au and Mo have a lower resistivity than Ag (that is, low impedance), such that the power signal lines 60 reduce the drop of the address voltage and the delay of the control signal.

Also, the address electrodes 13 and the power signal lines 60 may include Ag mixed with a material. Thus, the Ag content of the address electrodes 13 may be different from the Ag content of the power signal lines 60 according to the relative mixture of the material and the Ag. For instance, the material included in the address electrodes 13 and the power signal lines 60 may have lower or higher resistivity than Ag. When the material has a lower resistivity than Ag, more of the Ag having the relatively higher resistivity is included in the mixture of the Ag and the material used in the address electrodes 13 than in mixture of the material and the Ag used in the power signal lines 60. In contrast, when the material has a higher resistivity than Ag, more of the Ag having the relatively lower resistivity is included in the mixture of the Ag and the material used in the power signal lines 60 than in the mixture of the Ag and the material used in the address electrodes 13.

As described above, the address electrodes 13 and the power signal lines 60 are made of the different materials such that the formation process of the rear substrate 11 of the PDP 10 includes the formation process of the address electrodes 13 and the formation process of the power signal lines 60. The formation process of the address electrodes 13 and the formation process of the power signal lines 60 are separately executed.

Again referring to FIG. 2, the TCP 72 is connected to the power signal lines 60 and is connected to address electrode terminals 18 such that the address voltage and the control signals generated in the driver IC 73 are applied to the address electrodes 13. A sealing member 50 seals the connection of the power signal lines 60 and the TCP 72, and the power signal lines 60, thereby protecting the power signal lines 60 and the connection from the external environment.

The driver IC 73 includes a heat dissipation pad 74 supported by a cover plate 75, or thermal grease (not shown). The cover plate 75 is installed at a bent portion 33 of the chassis base 30 by the setscrew 32, thereby protecting the TCP 72.

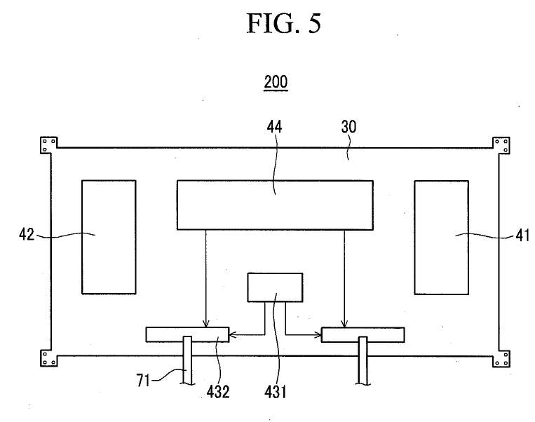

FIG. 5 is a rear view of a chassis base of a plasma display device 200 according to an exemplary embodiment of the present invention. Referring to FIG. 5, as compared to the plasma display device 100 shown in FIGS. 1 through 4, the plasma display device 200 according to the second exemplary embodiment includes a mini-board assembly 432, thereby further reducing the constituents of the address buffer board assembly. That is, the constituents of the conventional address buffer board assembly are formed at a logic board assembly 431, and at the mini-board assembly 432 and the power signal lines (not shown). Accordingly, as compared with the first exemplary embodiment in FIGS. 1 through 4, the plasma display device 200 is disadvantages in that it increases manufacturing cost. However the manufacturing cost is for the plasma display device 200 is still reduced compared with the constituents including the conventional address buffer board assembly.

According to the inclusion of the mini-board assembly 432, among the voltages and control signals controlling the address electrode (not shown), the address voltage Va that is a relative high voltage is applied to the mini-board assembly 432 from the power supply board assembly 44. Accordingly, the address voltage Va is applied to the address electrodes through the interface FPC 71, the power signal lines not shown, and TCP 72 in the mini-board assembly 432.

As a relative low voltage, a ground of the driver IC, the driving voltage Vcc of the driver IC, the drive IC control signal, the clock signal, and the address data signal are applied to the mini-board assembly 432 from the logic board assembly 431. Accordingly, the control signals of the low voltage are applied to the TCP (not shown) and the driver IC through the interface FPC 71 and the power signal lines in the mini-board assembly 432.

When the plasma display device 200 reduces the functions of the conventional address buffer board assembly and includes the mini-board assembly 432, the power signal lines are equally provided on the edge of the PDP (not shown) such that the effect of the impedance improvement may be obtained as in the plasma display device 100.

According to an exemplary embodiment of the present invention, the constituents related to the removing/reducing of the address buffer board assembly are formed on the edge of the PDP such that the constituents of the plasma display device may be simplified and the manufacturing cost may be reduced. That is, the power signal lines connecting the integrated board assembly and the address electrodes are formed on the edge of the PDP that is not conventionally used such that the manufacturing cost may be reduced.

Also, the power signal lines formed on the edge of the PDP have lower resistivity than that of the electrodes or the address electrodes of the PDP such that the impedance characteristic may be improved. That is, a voltage drop and signal delay may be reduced in the power signal lines.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel (PDP) including a plurality of electrodes;
power signal lines disposed at an edge of the PDP to supply power to electrodes and which are spaced apart from the electrodes on the edge, a resistivity of the power signal lines being lower than a resistivity of the electrodes;
a printed circuit board assembly (PBA) to drive the PDP;
a chassis base including a first surface supporting the PDP and a second surface on which is mounted the PBA; and
an interface flexible printed circuit (FPC) through which the power signal lines are connected to the electrodes.

2. The plasma display device of claim 1, wherein the power signal lines include Au and/or Mo.

3. The plasma display device of claim 1, wherein each of the power signal lines and the electrodes comprises a mixture including Ag and a material having a higher resistivity than a resistivity of Ag, the power signal lines have a higher content of Ag in the mixture than a content of the Ag in the mixture used in the electrodes.

4. The plasma display device of claim 1, wherein the electrodes and the power signal lines are made of different materials.

5. The plasma display device of claim 1, wherein
the electrodes include an address electrode, and
the FPC is connected to another flexible printed circuit on which is mounted a driver IC which generates a control signal to be applied to the address electrode.

6. A plasma display device comprising:
a plasma display panel (PDP) including a front substrate, a rear substrate, a plurality of electrodes between the front substrate and the rear substrate, and power signal lines separated from the plurality of electrodes and formed at the rear substrate;
a chassis base close to the rear substrate; and
a plurality of printed circuit board assemblies (PBAs) mounted to the chassis base,
wherein:
the power signal lines transmit power and a signal used to drive the plurality of electrodes generated from at least one of the PBAs, and
a resistivity of the power signal lines is lower than a resistivity of the electrodes.

7. The plasma display device of claim 6, wherein the power signal lines include one of Au and Mo.

8. The plasma display device of claim 6, wherein
each of the power signal lines and the electrodes comprises a mixture including Ag and a material having a higher resistivity than a resistivity of Ag, and
the power signal lines have a higher content of Ag in the mixture than a content of the Ag in the mixture used in the electrodes.

9. The plasma display device of claim 6, wherein the electrodes and the power signal lines are made of different materials.

10. The plasma display device of claim 6, wherein
the electrodes includes an address electrode,
the address electrode and the power signal lines are connected by a flexible printed circuit (FPC), and
the FPC is mounted with a driver IC which generates a control signal to be applied to the address electrode according to the signal received from the at least one PBA.

11. A plasma display device comprising:
a plasma display panel (PDP) including a plurality of electrodes;
a printed circuit board assembly (PBA) to drive the PDP, the PBA comprising a sustain board assembly, a scan board assembly, a logic board assembly, a mini-board assembly, and a power supply board assembly;
an interface flexible printed circuit (FPC);
another flexible printed circuit mounted with a driver IC; and
a chassis base including a first surface supporting the PDP and a second surface mounted with the PBA,
wherein
the mini-board assembly is provided between the logic board assembly and the FPC thereby controlling an address electrode among the electrodes,
the PDP includes
power signal lines formed on an edge and connected to the mini-board assembly by the FPC, and
the power signal lines are connected to the address electrode by the another flexible printed circuit mounted with the driver IC, and
the power signal lines are made of a material having a lower resistivity than a resistivity of the address electrode.

12. The plasma display device of claim 11, wherein the mini-board assembly applies the voltage applied from the power supply board assembly to the address electrode as an address voltage by passing through the FPC, the power signal lines, and the another flexible printed circuit.

13. The plasma display device of claim 12, wherein the power signal lines include one of Au and Mo.

14. The plasma display device of claim 11, wherein:
each of the power signal lines and the electrodes comprises a mixture including Ag and a material having a higher resistivity than a resistivity of Ag, and
the power signal lines have a higher content of Ag in the mixture than a content of Ag in the mixture used in the address electrodes.

15. The plasma display device of claim 11, wherein the address electrode and the power signal lines are made of different materials.
